(19) United States
(12) Patent Application Publication
(10) Pub. No.: US 2002/0069546 A1
(43) Pub. Date: Jun. 13, 2002

(54) Adjustable tile spacing apparatus

(76) Inventor: Curtis A. E. Claxton, St. Croix, VI (US)

Correspondence Address: Law Offices of John D. Gugliotta, P.E., Esq., 202 Delaware Building, 137 South Main Street, Akron, OH, 44308, US

(21) Appl. No.: 09/736,485

(22) Filed: Dec. 13, 2000

(51) Int. Cl. G01B 5/00

(52) U.S. Cl. 33/527; 33/DIG. 20

(57) ABSTRACT

And adjustable tile spacing apparatus is provided for laying tiles in a consistent pattern with perfect spacing relative to one another so as to obtain grout joints of uniform width.

### RELATED APPLICATIONS

The present invention was first described in Disclosure Document No. 473,509 filed on May 2, 2000. There are no previously filed, nor currently any co-pending applications, anywhere in the world.

### BACKGROUND OF THE INVENTION

1. Field of the Invention

The present invention relates generally to devices for laying tiles for obtaining grout joints of uniform width and, more particularly, to an adjustable tile spacing apparatus.

2. Description of the Related Art

Anyone who has ever installed tile products before knows the aggravation associated with it. Not only do the individual pieces have to be cut just right, but when it is laid down, it must be set in a perfect, consistent pattern. A part of this pattern is the spacing between each piece which will later allow for grout to be installed. Plastic spacers can be set to aid in this process, but they must be moved individually when the next piece is to be installed. Additionally, the plastic only allows for one dimension to be set at a time, thus multiple spacers must be set for just one more piece of tile. This practice will result in the user trying to juggle the tile along with several spacers with less than satisfactory results. Finally, the plastic is difficult to clean, and will wear with time affecting grout line consistency. While these problems are difficult for the professional tile setter, they pose almost insurmountable problems for the do-it-yourselfer.

Accordingly, a need has developed for a device that overcomes the problems associated with establishing consistent spacing when setting tiles on floors. The development of the adjustable tile spacing apparatus fulfills this need.

A search of the prior art did not disclose any patents that read directly on the claims of the instant invention; however, the following references were considered related. The following patents disclose a method for installing a laminated tile: U.S. Pat. No. 5,401,343 issued in the name of Owens; U.S. Pat. No. 5,208,086 issued in the name of Owens; and U.S. Pat. No. 4,931,331 issued in the name of Owens.

The following patents describe a ceramic tile spacing gauge and tile holder: U.S. Pat. No. 5,359,783 issued in the name of Smith; and U.S. Pat. No. 4,860,723 issued in the name of Fortin.

U.S. Pat. No. 5,667,190 issued in the name of Scott et al. discloses an object bracket holder for concrete forms.

U.S. Pat. No. 5,062,913 issued in the name of Owens et al. describes a laminated tile product and method for producing the same.

U.S. Pat. No. 4,899,455 issued in the name of Bovino et al. discloses a tile squaring rod.

U.S. Pat. No. 4,712,309 issued in the name of Kingston et al. describes an adjustable template for positioning tiles of various sizes.

U.S. Pat. No. 2,642,674 issued in the name of Schell discloses an implement for laying square tile.

Consequently, a need has been felt for providing a device which allows tiles on floors to be set with greater ease and consistency in a manner which is quick and effective as well.

### SUMMARY OF THE INVENTION

Therefore, it is an object of the present invention to provide an adjustable tile spacing apparatus which aids in setting floor tile and provides for perfect spacing between tiles.

It is another object of the present invention to provide a device which keeps grout lines consistent and establishes a consistent tile pattern.

It is still another object of the present invention to provide a device which can be used with any type of tile material.

It is still another object of the present invention to provide a device having an I-shaped frame for providing spacing at all four corners of tile.

It is another object of the present invention to provide a device having an I-shaped frame which is adjustable in both width and length dimensions to suit all sizes and types of tiles.

It is another object of the present invention to provide a device having a rubber handle for comfort.

It is another object of the present invention to provide spacers mounted on prongs from above a tile surface for providing for the actual grout line spacing.

It is another object of the present invention to provide spacers supplied in “X”, “L”, “T”, and linear shapes to allow installation of all tiles encountered.

It is another object of the present invention to provide spacers available in ⅛ inch and ¼ inch varieties.

Briefly described according to the preferred embodiment of the present invention, an adjustable tile spacing apparatus is provided for laying tiles in a consistent pattern with perfect spacing relative to one another so as to obtain grout joints of uniform width. The invention comprises an I-shaped main frame which is adjustable in both width and length dimensions, via the use of telescoping members and fasteners. This adjustment allows the invention to work with all sizes of tile work. In each corner of the frame, a spacer is located. The spacer can be an X-shape, a T-shape, an L-shape, or a linear shape. These spacers would be used in setting field pieces, edge pieces, corner pieces, and variable pieces respectively. The spacers would be available in ⅛ inch and ¼ inch varieties to allow for the construction of various sized grout line widths. A rubber handle with finger grips is provided for user comfort. The invention is simply moved along as each tile is set and provides perfect spacing for the next piece of tile to be set. The invention can be used with ceramic tile, clay tile, marble, slate, or virtually any material that is set with spacing for grout lines.

The use of the present invention allows tiles on floors to be set with greater ease and consistency in a manner which is quick and effective as well.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of an adjustable tile spacing apparatus according to the preferred embodiment of the present invention;

FIG. 2a is a side elevational view thereof;

FIG. 2b is a partial elevational view of showing the handle mounted to the outer member;

FIG. 3 is an exploded perspective view of the spacer receiving prong according to the preferred embodiment of the present invention;

FIG. 4 is a cross-sectional view of a spacer according to the preferred embodiment of the present invention;

FIG. 5 is a perspective view of various spacers; and

FIG. 6 is a perspective view of the linearly elongated handle.

### DESCRIPTION OF THE PREFERRED EMBODIMENT

1. Detailed Description of the Figures

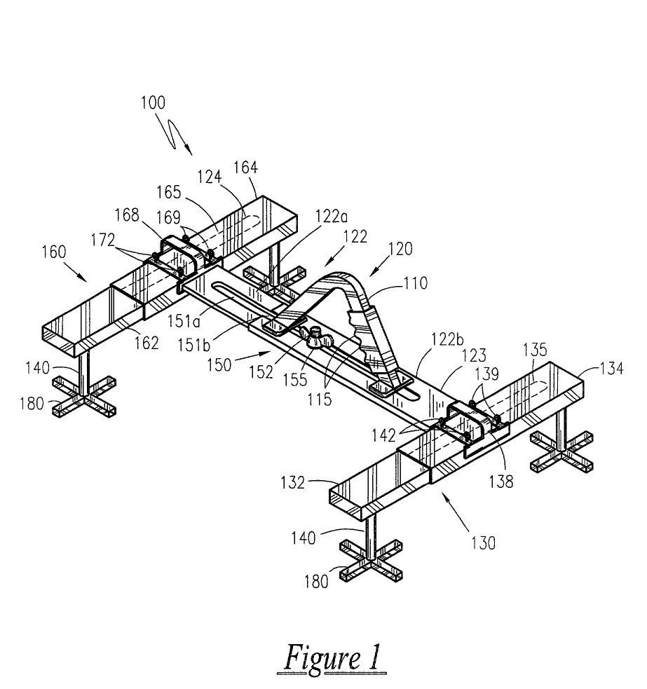

Referring now to FIGS. 1-4, an adjustable tile shaping apparatus 10 is shown, according to the present invention, comprised of an adjustable, I-shaped main frame 20 which includes a telescoping center member 22 and two telescoping vertical members 30, 60 for laying tiles in a consistent pattern with perfect spacing relative to one another so as to obtain grout joints of uniform width.

It is envisioned that the present invention may be used with any material such as ceramic, marble, clay, and slate which is set with spacing for grout lines.

The center member 22 has an anterior end 23 opposite a posterior end 24 and includes an inner member 22a telescoping inside an outer member 22b for varying a horizontal length thereof so as to aid in accommodating tiles of all sizes. The inner member 22a and the outer member 22b are of a linearly elongated, hollow, rectangular configuration constructed of a material such as stainless steel or high strength aluminum.

Once a desired horizontal length of the center member 22 has been provided, the inner member 22a and the outer member 22b are held into their position via a locking assembly 50. The locking assembly 50 is designed so as to slidably engage a linearly elongated slot 51 formed along an upper sidewall 26 of outer member 22b.

The locking assembly 50 includes a threaded bolt 52 welded perpendicularly along a linearly elongated centerline to an upper sidewall 27 of inner member 22a which extends through the slot 51 in the outer member 22b.

The inner member 22a and outer member 22b are securely locked in the desired horizontal position by a fastener 55, such as a washer followed by a wing nut threadably received by the bolt 52 and tightened thereon. Various horizontal lengths of the center member 22 can be easily obtained, whereupon a user simply loosens the fastener 55 thus permitting the inner member 22a to be extended away from or retracted into the outer member 22b. The user then chooses the desired horizontal length, and locks the center member 22 in such position via the fastener 55.

A first vertical member 30 is welded perpendicularly along a linearly elongated centerline of an inner sidewall 34 thereof to the outer member 22b at the anterior end 23 of the center member 22. The first vertical member 30 may be bolted or clamped to the outer member 22b; however, welding is the preferred method for permanent attachment. As bolts require holes, this method of attachment will leave surfaces exposed thereby being more susceptible to rust.

The first vertical member 30 is of a linearly elongated, hollow, rectangular configuration having a linearly elongated slot 31a formed along an upper sidewall 33 thereof, and a corresponding linearly elongated slot 31b formed along a lower sidewall 36 thereof, wherein the slots 31a, 31b are configured so as to slidably receive a prong bolt 42 from each of a pair of spacer receiving prongs 40 therethrough.

Each spacer receiving prong 40 is of a linearly elongated rectangular configuration which includes a threaded prong bolt 42 welded vertically to an upper end 43 thereof. The first vertical member 30 and the pair of spacer receiving prongs 40 are configured so as to provide various vertical settings, thereby aiding in accommodating tiles of all sizes.

Once a desired vertical setting has been provided, each spacer receiving prong 40 is held in such position by a fastener 55, such as a washer followed by a wing nut, threadably received by each prong bolt 42 and tightened thereon.

A second vertical member 60 is welded perpendicularly along a linearly elongated centerline of an inner sidewall 64 thereof to the inner member 22a at the posterior end 24 of the center member 22. The second vertical member 60 is of a linearly elongated, hollow, rectangular configuration having a linearly elongated slot 61 a formed along an upper sidewall 63 thereof and a corresponding linearly elongated slot 61b formed along a lower sidewall 66 thereof, wherein the slots 61a, 61b are configured so as to slidably receive a prong bolt 72 from each of a pair of spacer receiving prongs 70 therethrough.

Each spacer receiving prong 70 is of a linearly elongated rectangular configuration which includes a threaded prong bolt 72 welded vertically to an upper end 73 thereof. The second vertical member 60 and the spacer receiving prongs 70 are configured so as to provide various vertical settings, thereby aiding in accommodating tiles of all sizes.

Once a desired vertical setting has been provided, each spacer receiving prong 70 is held in such position by a fastener 55, such as a washer followed by a wing nut, threadably received by each prong bolt 72 and tightened thereon.

In order to facilitate the laying of tiles perpendicularly to each other for obtaining uniform and constant grout joints, spacers 80 are disclosed for being removably secured to a spacer receiving stem 82 of each spacer receiving prong 40, 70.

The spacers 80 are of a rectangular, hollow configuration, constructed of stainless steel, and are available in various shapes including but not limited to X-shape 80a, T-shape 80b, L-shape 80c, and linear-shape 80d (as shown in FIG. 5). The spacers 80 are available in ⅛ inch and ¼ inch varieties to allow for the construction of various sized grout line widths. The spacers 80 are used in setting field pieces, edge pieces, corner pieces and variable pieces.

The spacer receiving stem 82 is of a rectangular configuration welded to a lower end 44, 74 of each pair of spacer receiving prongs 40, 70 respectively, and extends vertically therefrom.

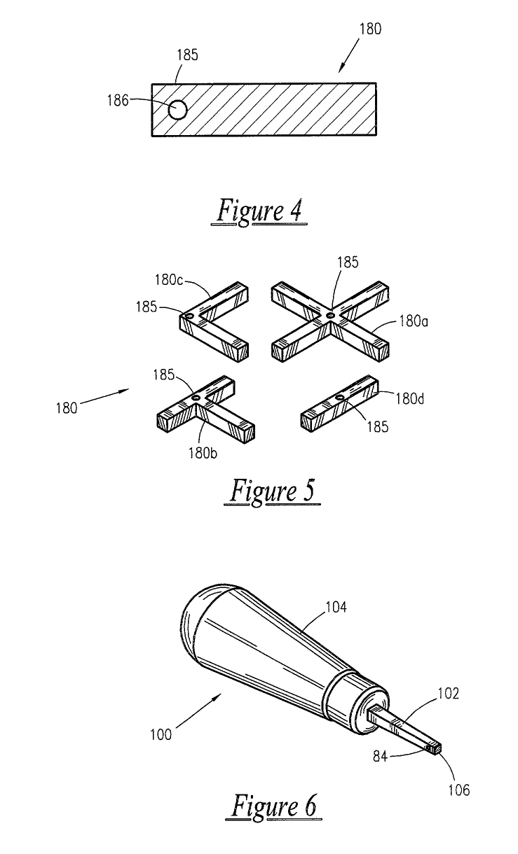

Referring now in greater detail to FIGS. 3 and 4, each spacer 80 includes a stem-receiving hole 85 formed on an upper sidewall thereof. The stem receiving hole 85 is designed so as to provide a snug fit when the spacer receiving stem 82 is inserted therein.

The spacer receiving stem 82 includes a spring-biased bead-like projection 84 located on a vertical sidewall thereof for being removably received by a corresponding bead receiving depression 86 formed on an inner wall within the hole 85 of each spacer 80 in order to provide a removably securable connection between the spacer receiving stem 82 and the stem receiving hole 85 of each spacer 80. After inserting the spacer receiving stem 82 within the hole 85, the bead receiving depression 86 receives the bead-like projection 84 of the spacer receiving stem 82, thereby biasing the spacer receiving stem 82 to a removably secured position within the hole 85. The spacer 80 can be removed by simply pulling the spacer 80 in a direction away from the spacer receiving stem 82 with sufficient force as is necessary so as to remove the bead-like projection 84 from within the depression 86. The connection and disconnection action of the spacer 80 is similar to that utilized with a typical ratchet tool.

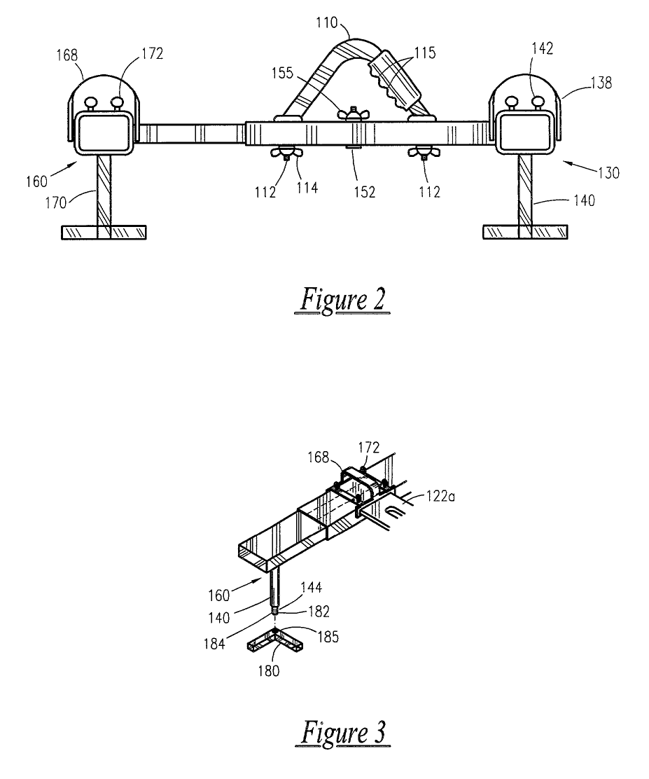

Referring now to FIGS. 1 and 2b, a rubber handle 90, of an arcuate configuration, is mounted via brackets 92 and fasteners 94, such as bolts, parallel along a linearly elongated centerline of the outer member 22b, and lateral to ends of the slot 51. The handle 90 is further defined as having a plurality of finger-gripping channels 96 to allow a user to obtain a firm and comfortable grasp of the handle 90. The arcuate configuration of the handle 90 creates a void between a lower surface thereof and the upper sidewall 26 of the outer member 22b, thereby allowing access by a user to horizontally adjust the center member 22.

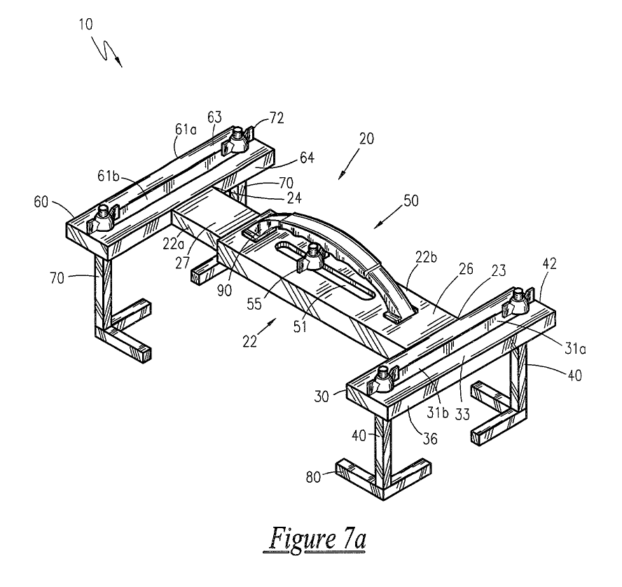

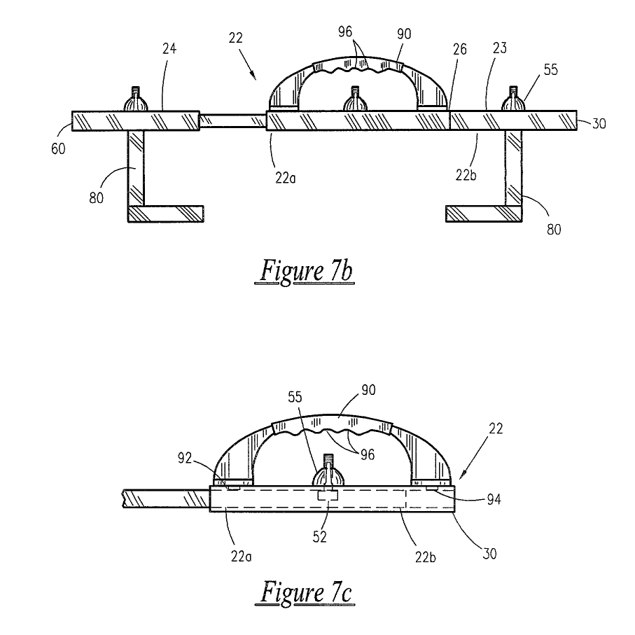

Referring now to FIG. 6, the spacers 80 are also adapted to be used with a linearly elongated handle 100, having a stainless steel, rectangular tip 102 for allowing a user to utilize a single spacer 80 upon the need arising The rectangular tip 102 has lateral surfaces converging inwardly with increased distance from a rubber handle portion 104 of the handle 100. The rectangular tip 102 includes a spacer receiving stem 106 designed and configured identical to the spacer receiving stem 82 of each pair of spacer receiving prongs 40, 70 so as to allow each spacer 80 to be removably secured to the spacer receiving stem 106 of the rectangular tip 102.

Being designed and configured so as to be horizontally and vertically adjustable, the present invention allows for the accommodation of tiles of all sizes.

2. Operation of the Preferred Embodiment

To use the present invention, the user removably secures a desired spacer 80 to each spacer receiving stem 82. The user then horizontally adjusts the center member 22, and vertically adjusts the first vertical member 30 and the second vertical member 60 for accommodating the desired tile for setting. The user securely locks the present invention in such position via fasteners 55 in order to lay tiles in a consistent pattern with perfect spacing relative to one another so as to obtain grout joints of uniform width. The invention is simply moved along as each tile is set and provides perfect spacing for the next piece of tile to be set.

The use of the present invention allows tiles on floors to be set with greater ease and consistency in a manner which is quick and effective as well.

Therefore, the foregoing description is included to illustrate the operation of the preferred embodiment and is not meant to limit the scope of the invention. As one can envision, an individual skilled in the relevant art, in conjunction with the present teachings, would be capable of incorporating many minor modifications that are anticipated within this disclosure. Therefore, the scope of the invention is to be broadly limited only by the following claims.

What is claimed is:

1. An adjustable tile spacing apparatus comprising:
an I-shaped main frame, said I-shaped main frame having a telescoping center member and two telescoping vertical members;
said center member having an anterior end opposite a posterior end and includes an inner member telescoping inside an outer member for varying a horizontal length thereof;
wherein said inner member and said outer member are of a linearly elongated, hollow, rectangular configuration.

2. The adjustable tile spacing apparatus of claim 1, further comprising a locking assembly for securing the relative position of said inner member to said outer member so as to adjust a desired horizontal length of said center member.

3. The adjustable tile spacing apparatus of claim 2, wherein said locking assembly slidably engages a linearly elongated slot formed along an upper sidewall of said outer member.

4. The adjustable tile spacing apparatus of claim 3, wherein said locking assembly further comprises a threaded bolt secured perpendicularly along a linearly elongated centerline to an upper sidewall of said inner member, which extends through said slot in said outer member.

5. The adjustable tile spacing apparatus of claim 1, further comprising a fastener for securing said inner member and said outer member in a desired horizontal position.

6. The adjustable tile spacing apparatus of claim 1, further comprising a first vertical member affixed perpendicularly along a linearly elongated centerline of an inner sidewall of said outer member at said anterior end of said center member, said first vertical member being of a linearly elongated, hollow, rectangular configuration having a linearly elongated slot formed along an upper sidewall thereof, and a corresponding linearly elongated slot formed along a lower sidewall thereof, wherein said respective slots are configured so as to slidably receive a prong bolt from each of a pair of spacer receiving prongs.

7. The adjustable tile spacing apparatus of claim 6,wherein each spacer receiving prong is of a linearly elongated rectangular configuration which includes a threaded prong bolt affixed vertically to an upper end thereof, and configured so as to provide various vertical settings.

8. The adjustable tile spacing apparatus of claim 6, further comprising a second vertical member affixed perpendicularly along a linearly elongated centerline of an inner sidewall thereof to said inner member at the posterior end of said center member, said second vertical member being of a linearly elongated, hollow, rectangular configuration having a linearly elongated slot formed along an upper sidewall thereof and a corresponding linearly elongated slot formed along a lower sidewall thereof, wherein said respective slots are configured so as to slidably receive a prong bolt from each of a pair of spacer receiving prongs.

9. The adjustable tile spacing apparatus of claim 8, wherein each spacer receiving prong is of a linearly elongated rectangular configuration which includes a threaded prong bolt affixed vertically to an upper end thereof, and configured so as to provide various vertical settings.

10. The adjustable tile spacing apparatus of claim 1, further comprising a handle affixed parallel along a linearly elongated centerline of said outer member.
